(19) United States
(12) Patent Application Publication
(10) Pub. No.: US 2014/0162480 A1
(43) Pub. Date: Jun. 12, 2014

(54) Electrical Outlet Cover with Safety Lock

(71) Applicants: Michael J. Schutte, Cornelius, NC (US); Richard W. Turner, Mooresville, NC (US)

(72) Inventors: Michael J. Schutte, Cornelius, NC (US); Richard W. Turner, Mooresville, NC (US)

(21) Appl. No.: 14/102,490

(22) Filed: Dec. 10, 2013

Related U.S. Application Data
(60) Provisional application No. 61/735,554, filed on Dec. 10, 2012.

(51) Int. Cl. H01R 13/447

(52) U.S. Cl. CPC H01R 13/447
USPC 439/142

(57) ABSTRACT

An outlet cover for an electrical outlet. The outlet cover includes a plate having at least one opening sized and positioned to receive an electrical outlet, a lid hingedly attached to the plate so that the lid can be moved between an open position that allows access to the electrical outlet and a closed position wherein the lid is in a locked position covering the electrical outlet, and a locking assembly having a locking pin. The lid includes a latch which cooperates with the locking pin in order to lock the lid in a closed position or release the lid for opening it for access to the electrical outlet.

### CROSS REFERENCE TO RELATED APPLICATIONS

This application claims the benefit of U.S. Provisional Application No. 61/735,554, filed Dec. 10, 2012, and U.S. Provisional Application No. 61/736,002, filed Dec. 11, 2012, both of which are incorporated herein by reference in their entirety.

### BACKGROUND OF THE INVENTION

1. Field of the Invention

The present invention relates to the field of safety covers for electrical outlets and, more specifically, to an outlet cover for electrical outlets that has a safety lock to restrict children from accessing the electrical outlet.

2. Description of the Related Art

Numerous devices are known to restrict children from accessing an electrical outlet. For example, a pronged safety plug may be inserted into an outlet. However, when it is desired to use the electrical outlet, the safety plug must be removed whereupon it may be misplaced and lost. Additionally, it is often difficult to grasp and remove the safety plug from the socket.

Other known devices utilize various enclosures or mechanisms to restrict access to an electrical outlet. These devices may be difficult to use, particularly for an elderly person; have removable parts that may become lost; and/or are not self-locking thereby requiring multiple steps in order to limit access to the outlet.

Accordingly, there is a need in the art for continued improvement in the art of electrical outlet covers that have a safety lock to restrict children from accessing an electrical outlet. Further needed in the art is for an electrical outlet cover that this is self-locking. Still further needed is for an outlet cover that does not have any parts that need to be removed when locking or unlocking the outlet cover.

### BRIEF SUMMARY OF THE INVENTION

To achieve the foregoing and other objects, the present invention, as embodied and broadly described herein, provides various embodiments of an electrical outlet cover that has a safety lock to restrict children from accessing an electrical outlet.

The present invention is an outlet cover for an electrical outlet. In an embodiment, the outlet cover includes a plate having at least one opening capable of receiving an electrical plug; a lid hingedly attached to the plate so that the lid can be moved between an open position that allows access to the electrical outlet and a closed locked position wherein the electrical outlet is covered by the lid and the lid cannot be freely moved to the open position, the lid having a latch; a locking assembly having a pin movable between an locked position, a transitional position, and an opening position; and wherein the pin secures the latch whereby the lid is locked in a closed position.

In an embodiment the invented outlet cover includes a plate having an opening capable of receiving an electrical plug; a lid hingedly attached to the plate so that the lid can be moved between an open position that allows access to the opening and a closed locked position wherein the opening is covered by the lid and the lid cannot be freely moved to the open position; and a locking assembly have a pin, the locking assembly being moveable between a first position wherein the lid is capable of being locked in the closed position by the pin and an open position wherein the lid may be freely moved to the open position.

### BRIEF DESCRIPTION OF THE DRAWINGS

The above described and other features, aspects, and advantages of the present invention are better understood when the following detailed description of the invention is read with reference to the accompanying drawings, wherein:

FIG. 1 is a top, left, front perspective view of an electrical outlet cover, in accordance with an embodiment of the present invention;

FIG. 2 is a top, left, front perspective view of the electrical outlet cover of FIG. 1, showing a lid of the outlet cover in an open position and the other lid locked in a closed position;

FIG. 2A is top, left, rear, perspective view of an electrical outlet cover similar to the outlet cover of FIG. 2, except that it has preexisting openings configured for application to a standard electrical outlet;

FIG. 3 is a front view of the electrical outlet cover of FIG. 2;

FIG. 4 is a left side elevational view of the outlet cover of FIG. 2;

FIG. 5 is front, left, perspective view the outlet cover of FIG. 2, but showing both lids of the outlet cover in open position;

FIG. 6 is a top plan view of the outlet cover of FIG. 2;

FIG. 7 is a rear view of the outlet cover of FIG. 2;

FIG. 8 is a bottom, right, rear perspective view of the outlet cover of FIG. 2;

FIG. 9 is a detail taken from FIG. 8, showing a latch and pin for locking a lid of the outlet cover;

FIG. 10 is a top, left, rear perspective view of the outlet cover of FIG. 2;

FIG. 11 is a bottom, right, rear perspective view of the outlet cover of FIG. 10, showing a locking assembly exploded from the outlet cover;

FIG. 12 is a top, left, rear perspective view of the outlet cover of FIG. 10, showing a locking assembly exploded from the outlet cover;

FIG. 13 is an exploded perspective view of the locking assembly of FIG. 11;

FIG. 14 is a rear view of the outlet cover of FIG. 2, showing interior details of a locking assembly with first and second locking pins being located in a locking position;

FIG. 15 is a rear view of the outlet cover of FIG. 2, showing interior details of a locking assembly with a first locking pin being located in a locking position and securing a first lid in a closed position and a second locking pin in an intermediate position wherein a second lid is being returned from an open position to a closed locked position;

FIG. 16 is a rear view of the outlet cover of FIG. 2, showing interior details of a locking mechanism with first and second locking pins being located in an unlocking position whereby each lid may freely be rotated to the open position for access to an electrical outlet;

FIG. 17 is a rear view of the outlet cover of FIG. 2, further showing a template insert suitable for accommodating application of the cover to a standard electrical outlet;

FIG. 18 is a top, left, rear perspective view of the outlet cover of FIG. 17;

FIG. 19 is a top, left, rear perspective view of the outlet cover of FIG. 18, showing the template spaced from the outlet cover;

FIG. 20 is a rear view of the outlet cover of FIG. 2, further showing a template insert suitable for accommodating application of the cover to a GFI electrical outlet;

FIG. 21 top, left, rear perspective view of the outlet cover of FIG. 20; and

FIG. 22 is a top, left, rear perspective view of the outlet cover of FIG. 21, showing the template spaced from the outlet cover.

### DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be considered as limited to the embodiments set forth herein. These exemplary embodiments are provided so that this disclosure will be both thorough and complete, and will fully convey the scope of the invention to those skilled in the art. Like reference numbers in the various Figures refer to like elements.

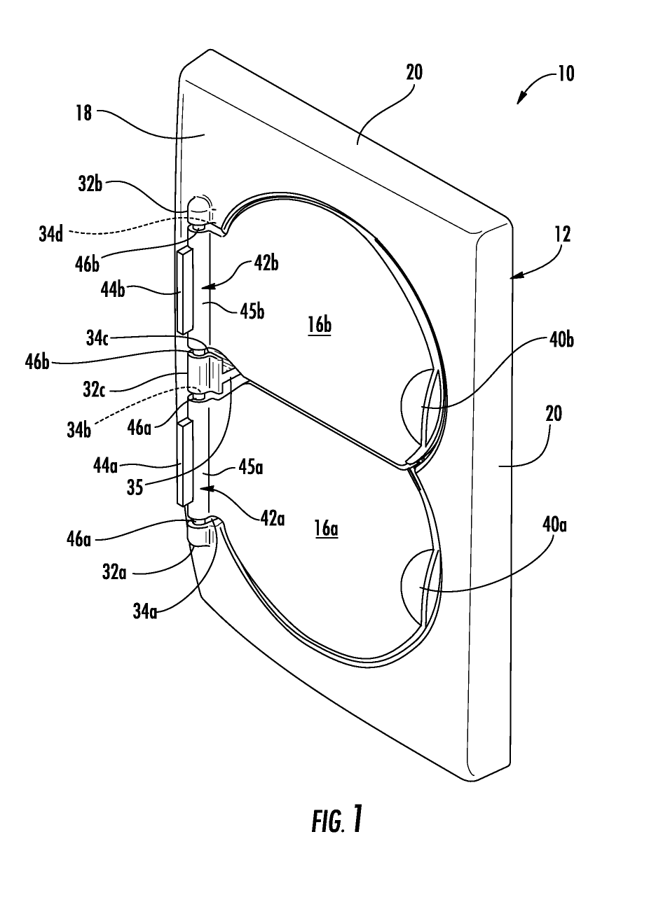

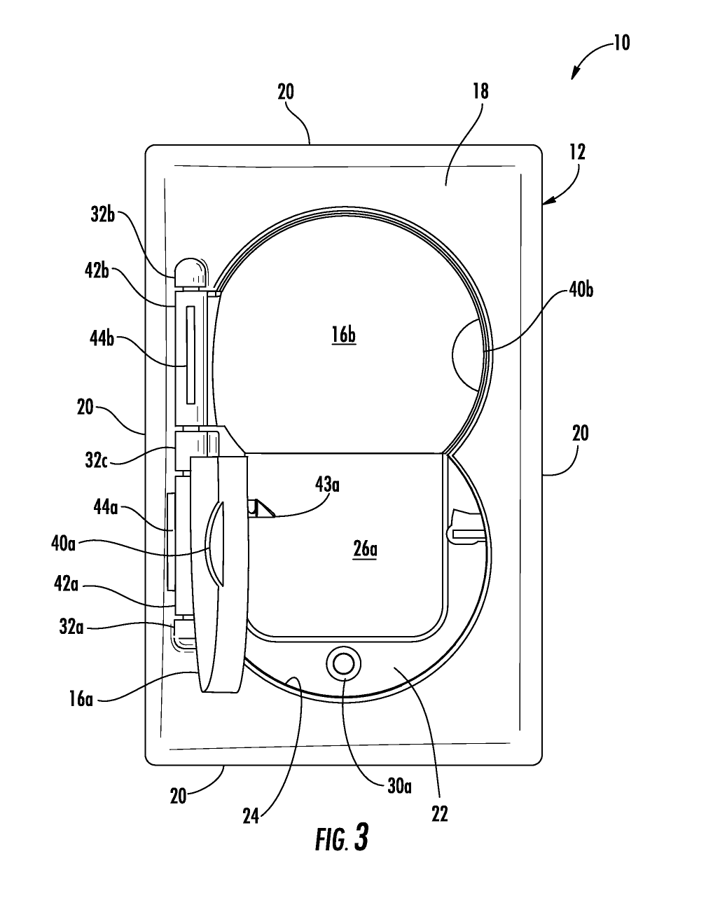

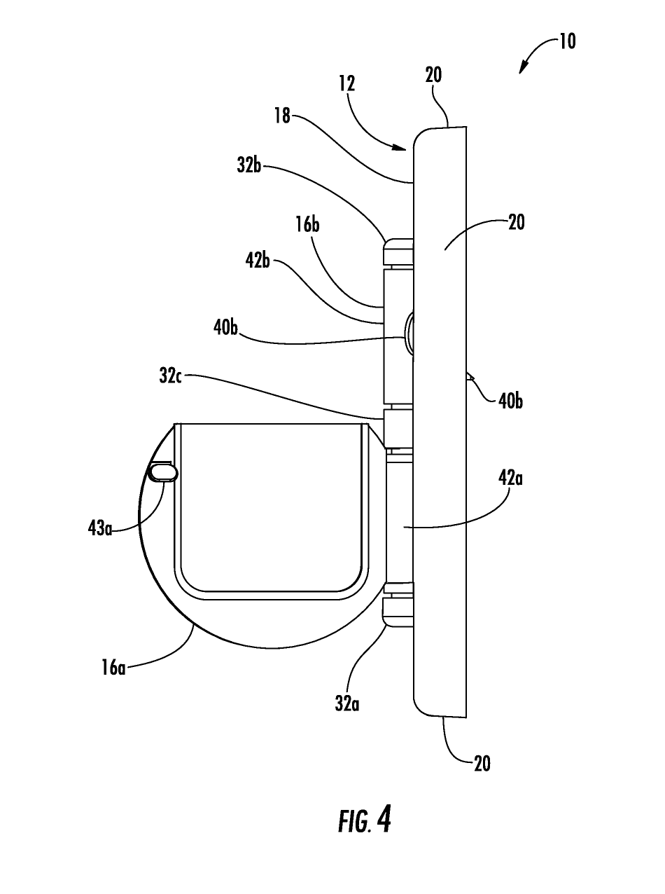

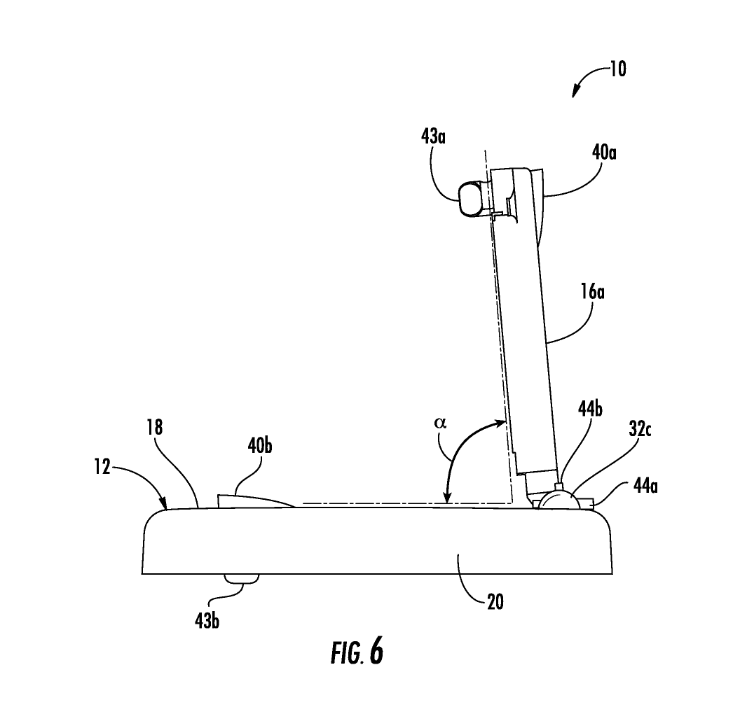

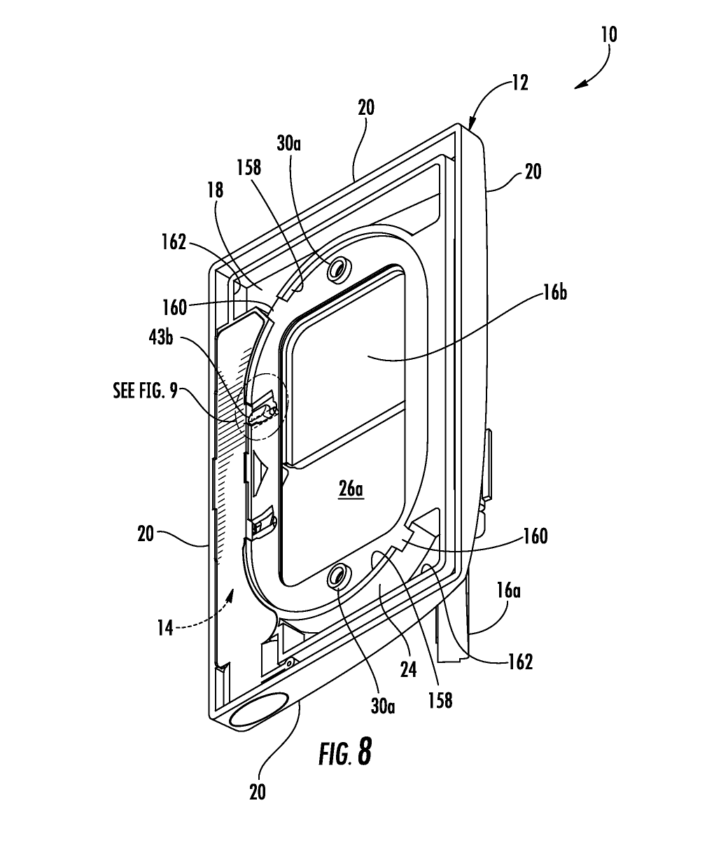

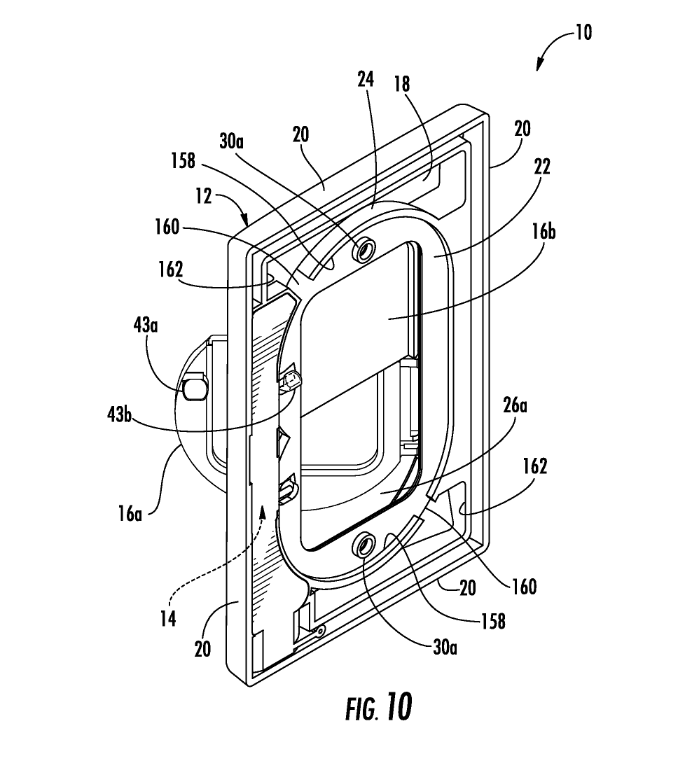

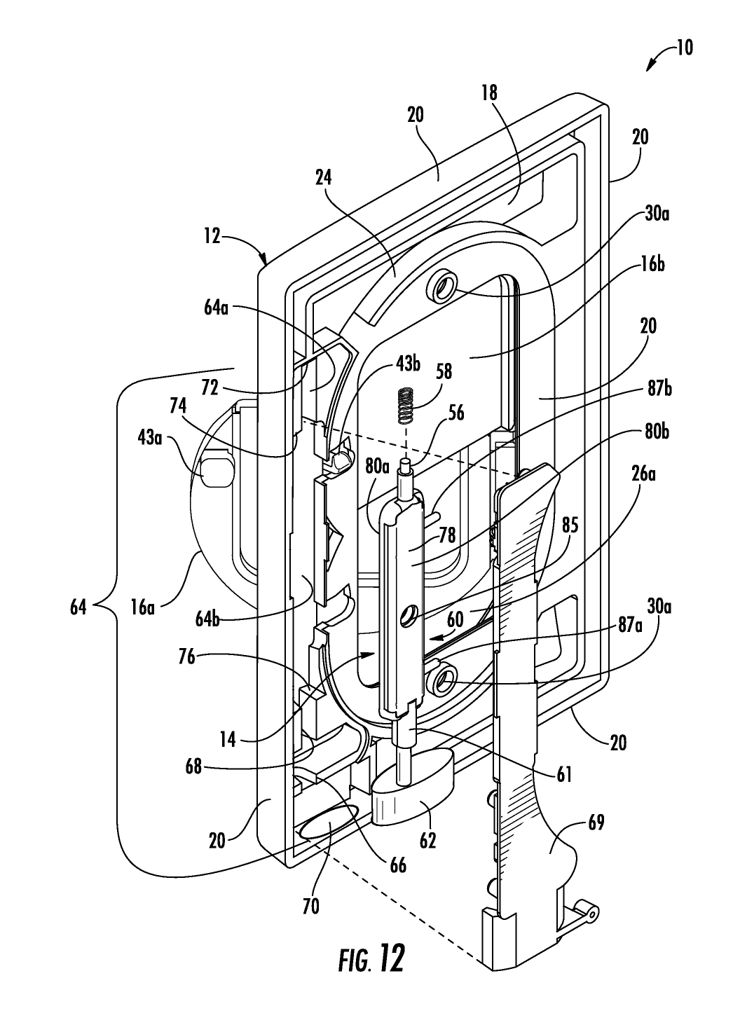

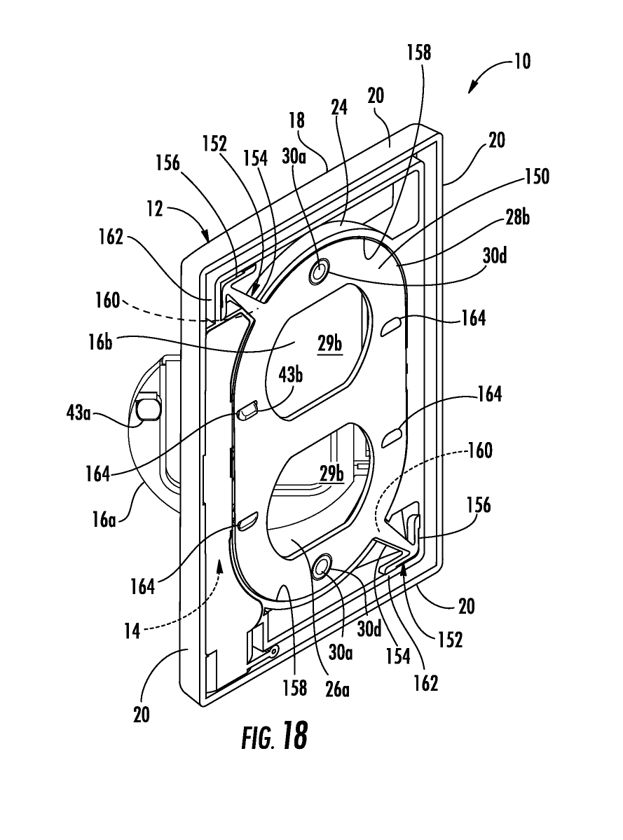

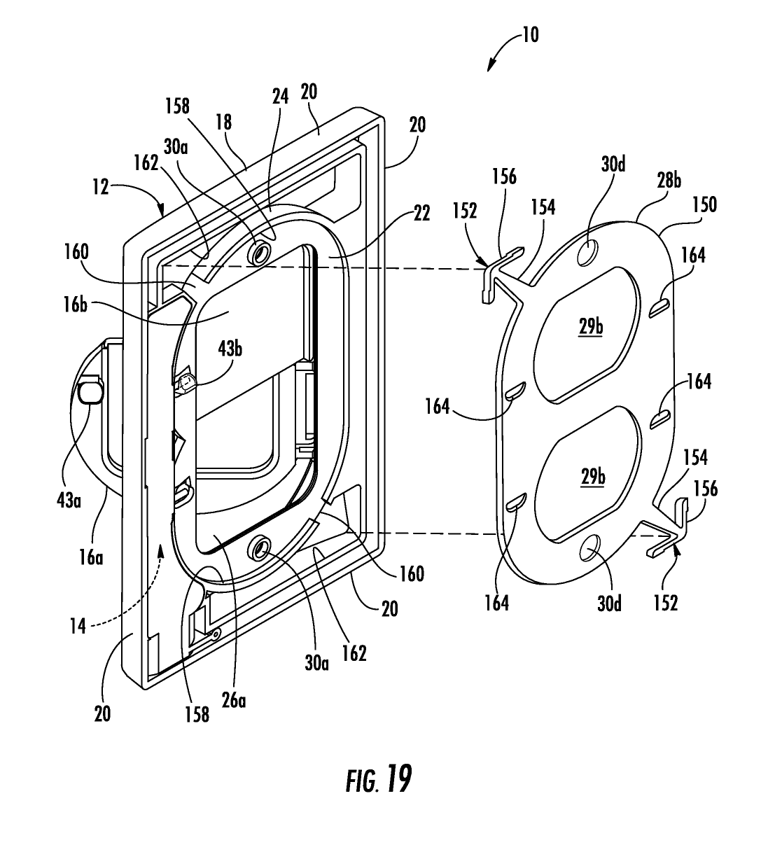

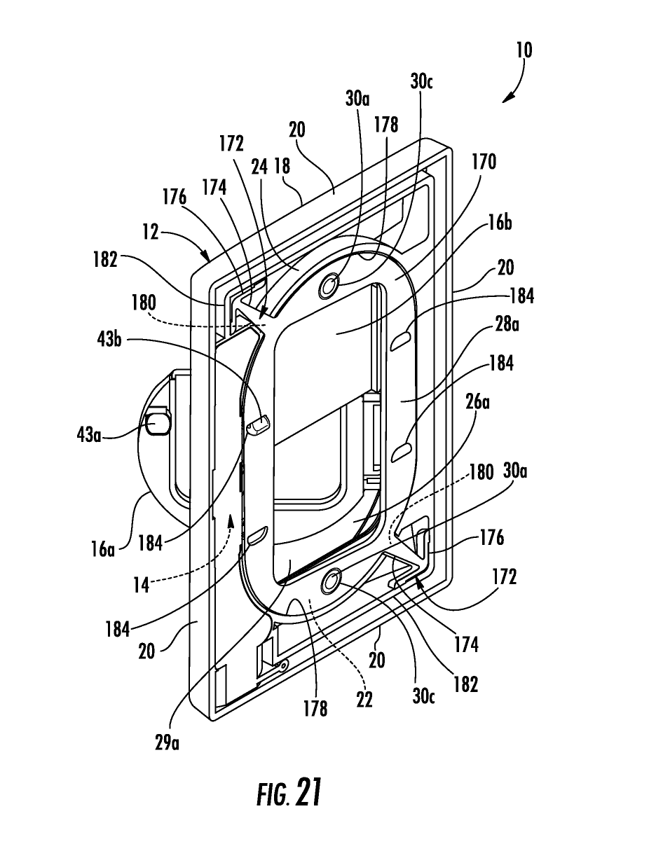

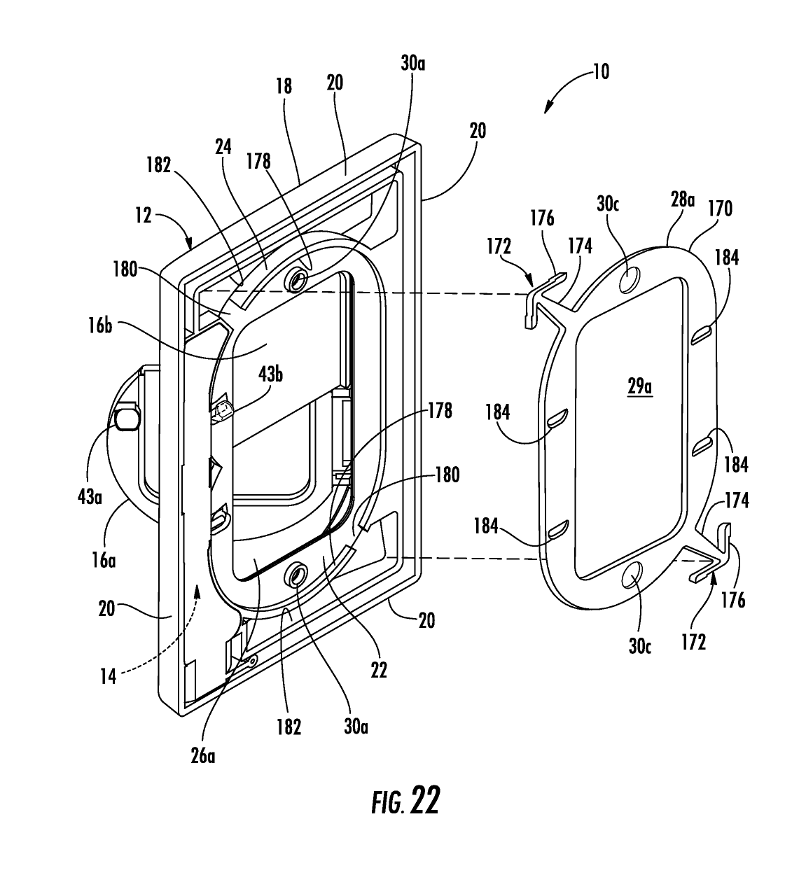

Referring to FIGS. 1-2, 3-12 and 14-22, an electrical outlet cover 10 is illustrated, in accordance with an embodiment of the present invention, for application to an electrical outlet (not illustrated). The outlet cover 10 includes a plate 12 having a shape and size to provide a protective barrier over an electrical box (not shown) in order to keep undesired foreign objects from entering therein; a locking assembly 14; and at least one hinged lid (typically two hinged lids 16a, 16b are provided to correspond to a pair of sockets as is conventional for electrical outlets) wherein each lid 16a, 16b may independently and selectively be locked in a closed position to restrict access to a corresponding socket or placed in an open position by being rotated outwardly relative to the plate 12 to allow access to a corresponding socket. Advantageously, the invented outlet cover 10 provides a measure of safety against accidental electrocution from an electrical outlet, particularly with regards to infants and young children.

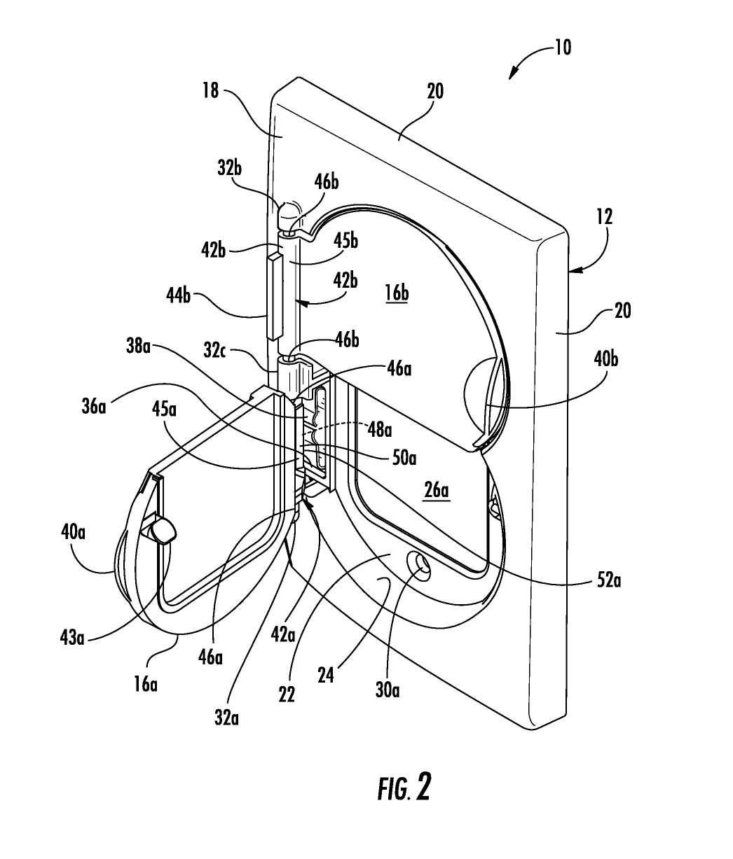

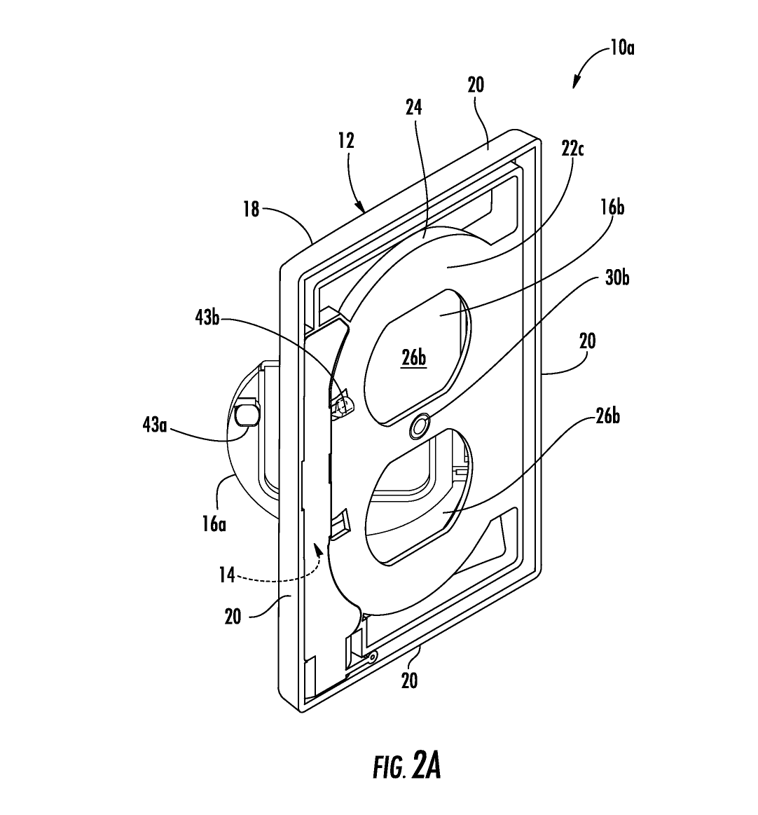

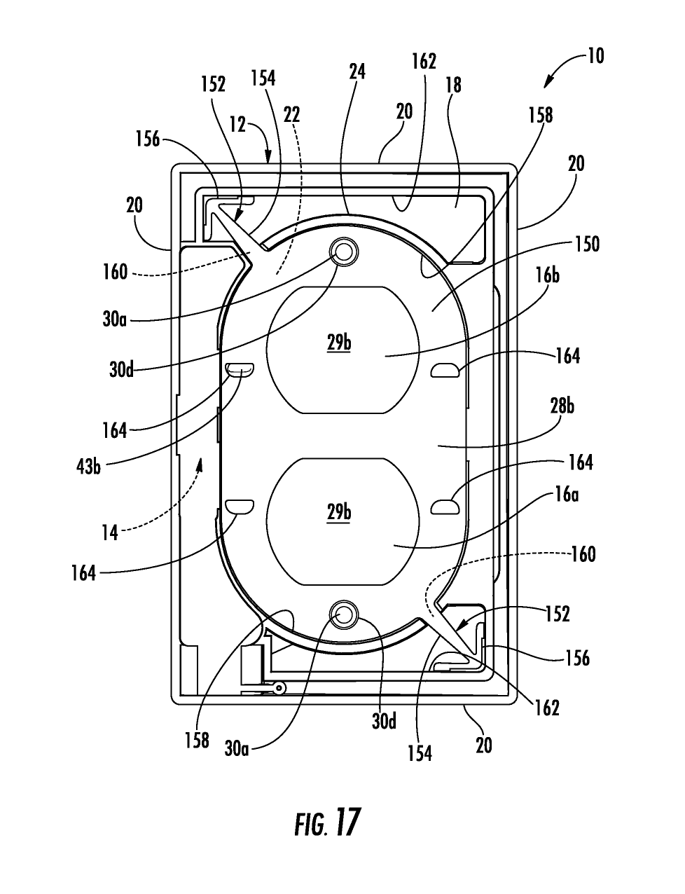

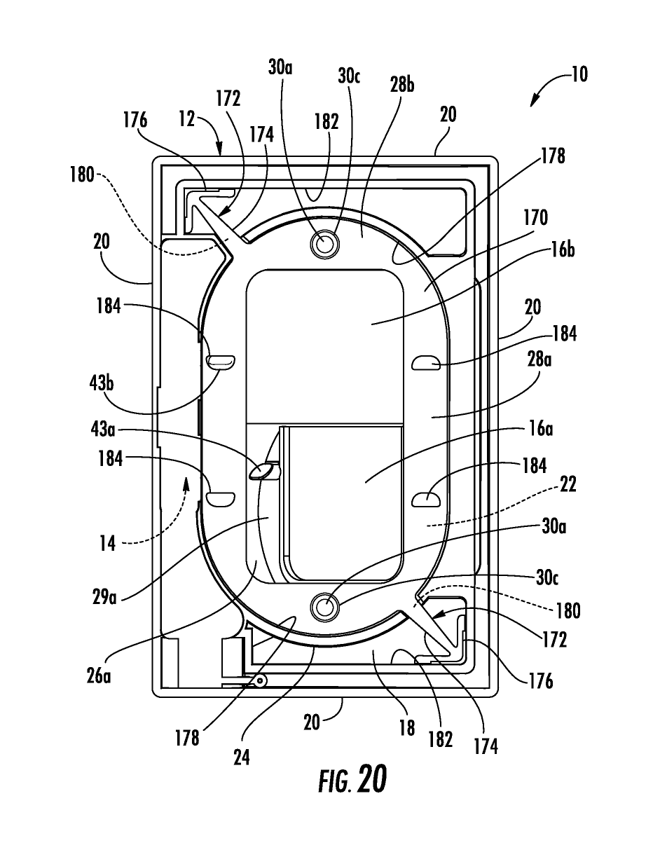

Referring to FIG. 2, the plate 12 has an exterior first section 18, a perimeter wall 20, a second section 22 spaced inward from the first section 18 by a connecting wall 24. One or more openings are provided in the second section 22 so that a plug may pass there-through to access a socket. For example and as illustrated in FIGS. 2, 3-12 and 14-16, an opening 26a provided in the second section 22 of the plate 12 may be shaped and sized to be suitable for use with a GFI receptacle, in particular a GFI receptacle duplex. An another example and referring to FIGS. 17-22, the opening 26a may also be adapted with interchangeable templates 28a, 28b for application of the outlet cover 10 to a standard electrical outlet (see FIGS. 17-19) or GFI outlet (see FIGS. 20-22). As a further example, FIG. 2A illustrates an alternative embodiment of an outlet cover 10a, having the same are substantially similar components (e.g. plate 12 with first section 18, perimeter edge 20 and connection wall 24; lids 16a, 16b with latches 43a, 43b; locking assembly 14; and etc.) as in the embodiment of outlet cover 10, except for configuration of the second section 22c which defines a pair of openings 26b that is suitable for use with a standard duplex receptacle. Thusly, outlet cover 10a is premade for application to a standard electrical outlet without use of the template 28a (see FIGS. 17-19).

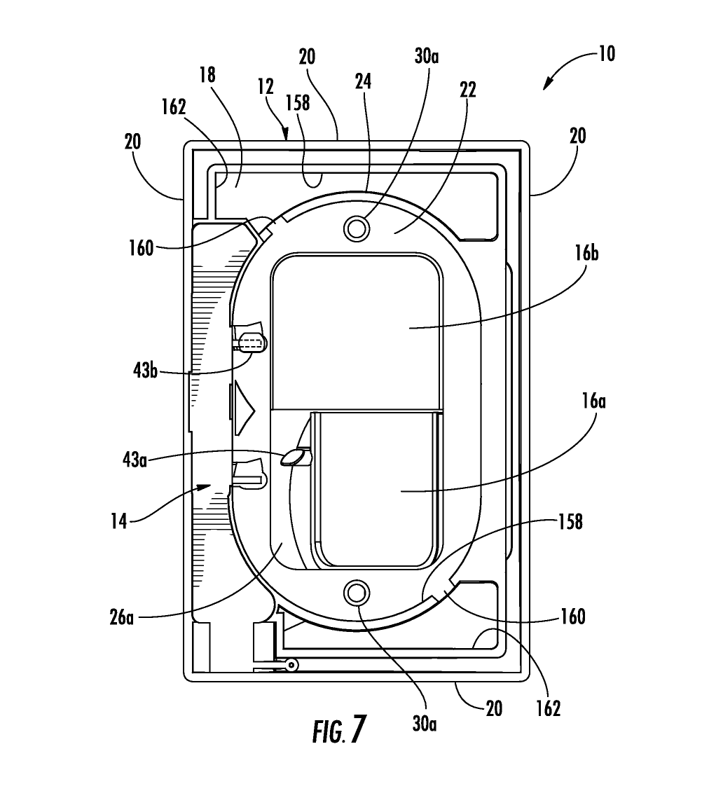

One or more small apertures, for example the pair of apertures 30a illustrated in FIG. 7 or the single aperture 30b illustrated in FIG. 2A, are also provided in the second section 22, 22c for securing the outlet cover 10, 10a to the electrical outlet via at least one mechanical fastener, for example with screws.

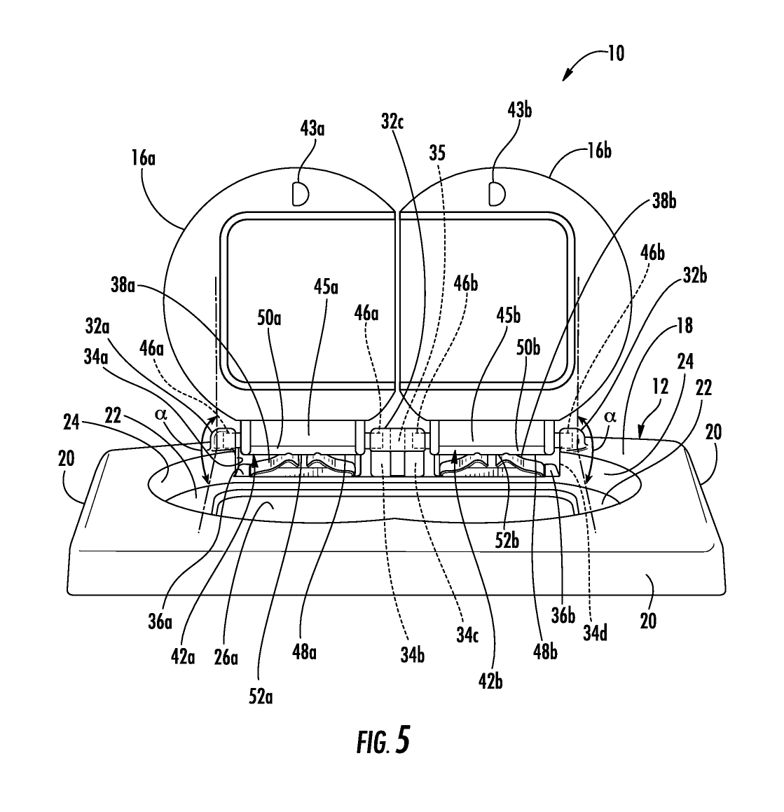

Referring to FIG. 5, the plate 12 also includes projected end housings 32a, 32b and a projected intermediate housing 32c which serve to secure the lids 16a, 16b to the base plate 12 and allow relative rotation between the lids 16a, 16b and plate 12. Each end housing 32a, 32b includes a channel 34a, 34d, and the intermediate housing 32c includes a pair of channels 34b, 34c divided by a central wall 35. Alternatively, but less preferred, the intermediate housing 32c may have a continuous singular channel (not illustrated), i.e. without the central wall 35, that serves the same purpose as the pair of channels 34b, 34c. Each of the channels 34a-34d has a depth, being elongate from their respective housing 32a-32c and extending rearward to below the first section 18 of the plate 12. The depth of the channels 34a-34d allows access for mounting the lids 16a, 16b within the housing 32a-32c during assembly of the outlet cover 10. The plate 12 further includes recesses 36a, 36b into which respective springs 38a, 38b are disposed.

Each lid 16a, 16b includes an outer lip 40a, 40b (FIG. 2) for aiding a person in gripping when opening the lid 16a, 16b; a shaft 42a, 42b for rotatably attaching the lid 16a, 16b to respective housings 32a-32c thereby allowing relative rotation between the lid 16a, 16b and the plate 12; a latch 43a, 43b that is used in conjunction with the locking assembly 14 for locking the lid 16a, 16b in the closed position; and a raised projection 44a, 44b (FIG. 1) that limits the degree to which the lids 16a, 16b can be rotated in the open direction before being stopped by engaging the plate 12 and may also be used to rotate the lid 16a, 16b open by pushing against the projection 44a, 44b.

Each shaft 42a, 42b includes an intermediate portion 45a, 45b and opposed end portions 46a, 46b that extend into the respective housings 32a-32c. Although other shaft configurations may be suitable, it is preferred that the intermediate portion 45a, 45b of each shaft 42a, 42b includes first and second surfaces 48a, 48b, 50a, 50b separated by a transitional edge or section 52a, 52b.

When in the fully open position, for example when an angle α between the lid 16a, 16b and first section 18 is in a range of 65 degrees to 120 degrees, more preferably in a range of 70 degrees to 100 degrees, and most preferably in a range of 80 degrees to 90 degrees, the spring 38a, 38b resiliently presses against the first surface 48a, 48b with sufficient force to hold the lid 16a, 16b in the open position.

Upon beginning to close the lid 16a, 16b, for example when the angle α between the lid 16a, 16b and first section 18 is less than 65 degrees, more preferably less than 70 degrees, and most preferably less than 90 degrees, the transitional section 52a, 52b is rotated onto the spring 38a, 38b causing the spring to act with force against on the transitional section 52a, 52b and thereby cause the lid 16a, 16b to close with sufficient force to lock the lid 16a, 16b in a closed position with the locking assembly 14. That is, by moving the lid 16a, 16b from the open position towards the closed position, the spring 38a, 38b will automatically close the lid 16a, 16b with sufficient force to activate the locking assembly 14. Advantageously, once placed in the open position, the lid 16a, 16b remains open allowing access to insert a plug an associated electrical outlet without interference of the lid 16a, 16b. To lock the lid 16a, 16b in the closed position, a person simply rotates the lid 16a, 16b towards the closed position by a few degrees until the spring 38a, 38b applies proper force to swing the lid 16a, 16b shut whereupon the locking assembly 14 secures the lid 16a, 16b in the closed position.

Alternatively, the outlet cover 10 may be configured whereby engagement between the spring 38a, 38b and shaft 42a, 42b is insufficient to maintain the lid 16a, 16b in the opened position, instead biasing the lid 16a, 16b towards the closed position. In this alternative, a person would need to hold open the lid 16a, 16b while inserting a plug into a corresponding socket. Upon release, the lid 16a, 16b would rest against the power cord or plug. In this embodiment, should the plug become disengaged from the outlet, unintentionally or otherwise, the lid 16a, 16b would automatically close under force of the spring 38a, 38b and become locked in the closed position.

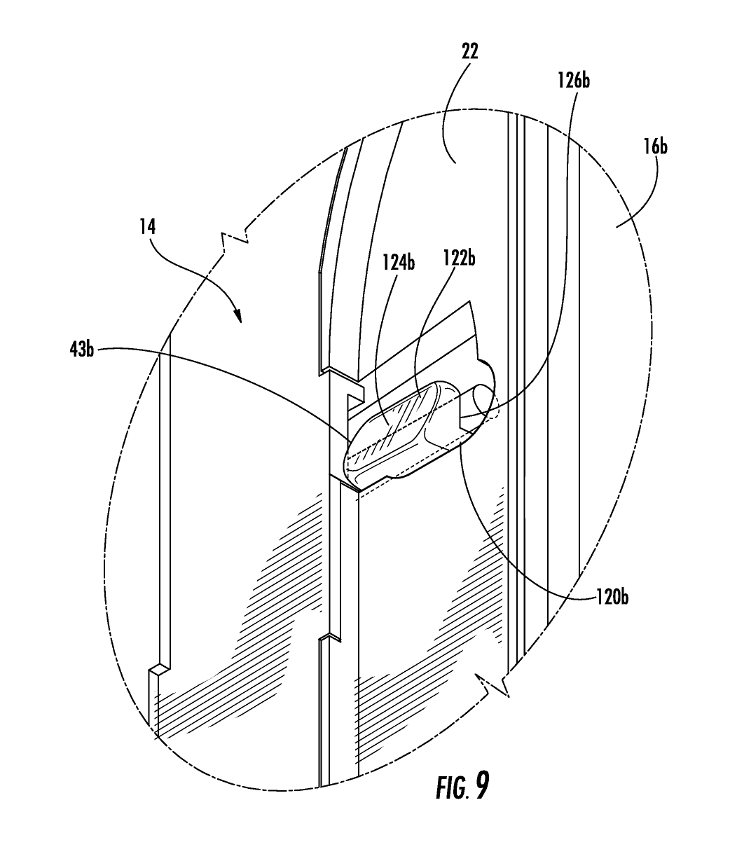

Referring to FIG. 9, the latch 43b includes first portion that extends from the lid 16b, and a second portion 122b forming an enlarged head of the latch 43b, the second portion 122b having a sloped surface 124b angled distally inwardly. The latch 43b defines a catch 126 for holding the second locking pin 87b. Each latch 43a, 43b has the same configuration and functionality. As such, the description of latch 43b equally applies to, and is incorporated into, the description of latch 43a (FIG. 2).

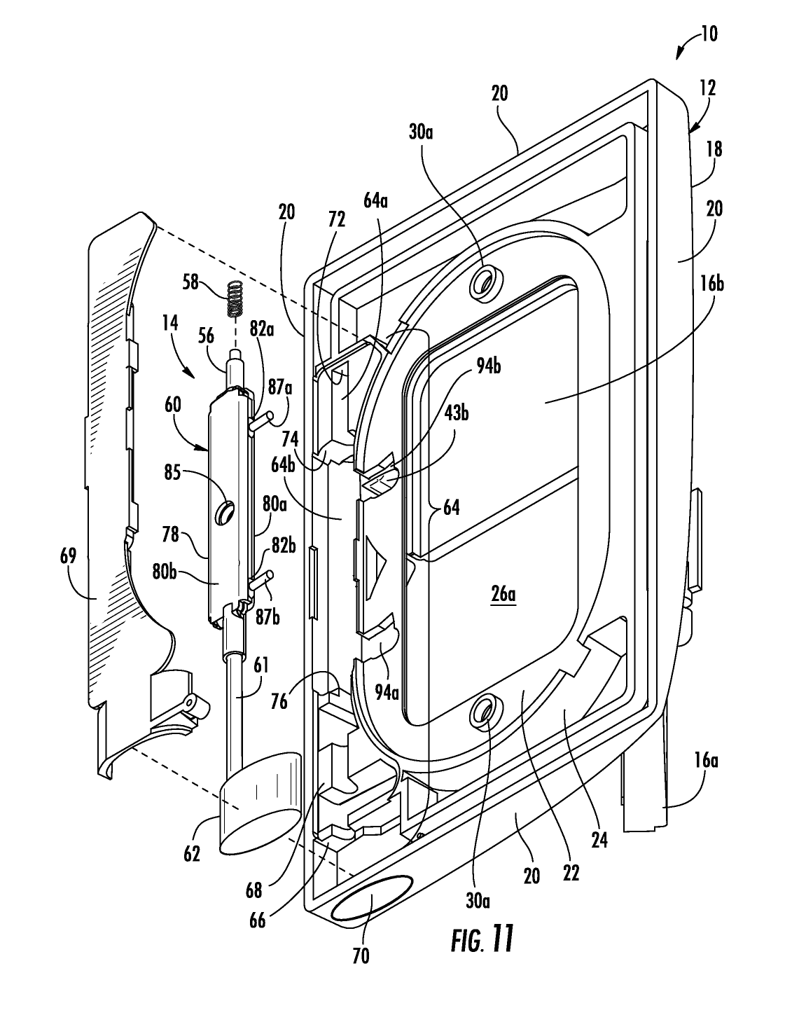

Referring to FIGS. 11 to 13, the locking assembly 14 includes a distal stepped shaft 56 which carries a spring 58, an intermediate body 60 attached to the distal shaft 56, and a proximal shaft 61 attached to the intermediate body 60, the proximal shaft 61 having an enlarged end 62 which serves as a button for actuation by a person. Structures of the plate 12 form a channel 64 in which the locking assembly 14 resides thereby limiting the locking assembly 14 to a predetermined range of movement. For example, such structures include a distal channel portion 64a into which the distal shaft 56 and spring 58 are disposed, intermediate channel portion 64b into which the intermediate body 60 is disposed, first and second lateral structures 66, 68 having channel portions into which the proximal shaft resides. A cover 69 is provide for enclosing the locking assembly 14 within the channel 64.

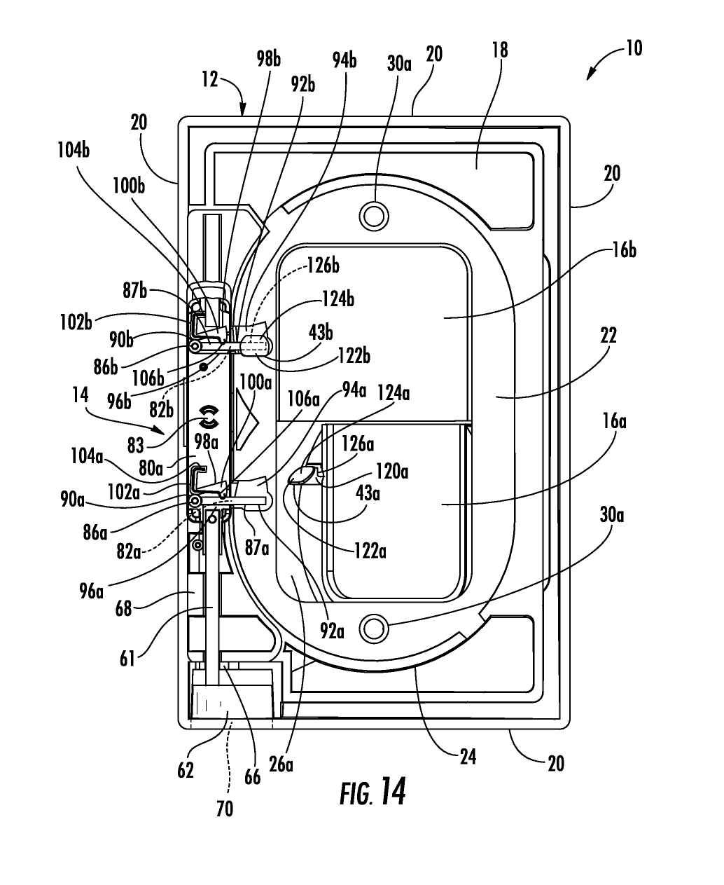

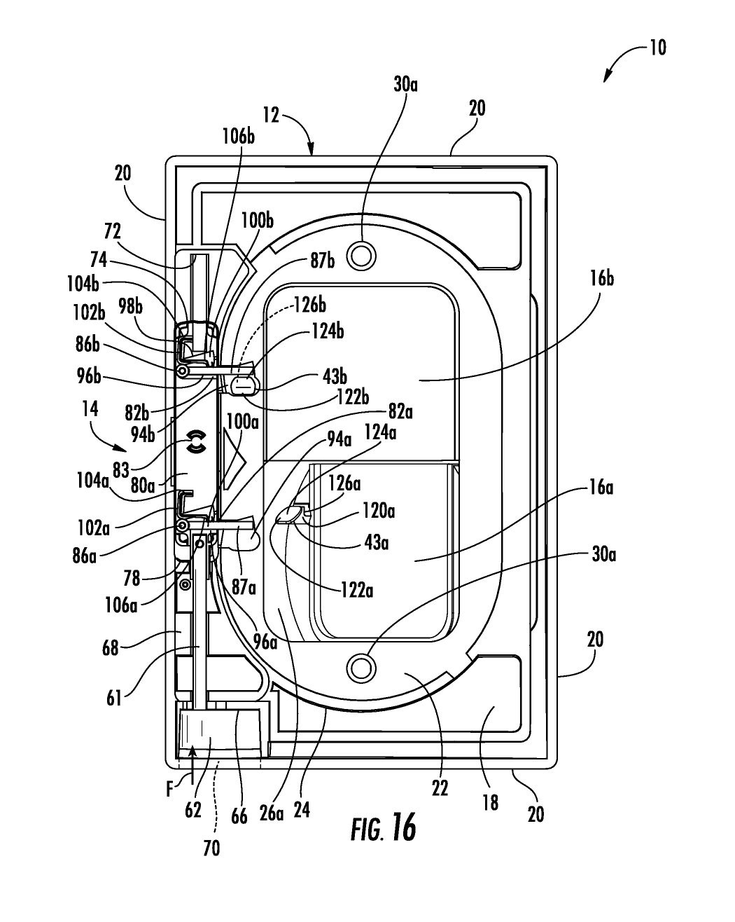

FIG. 14 illustrates the locking assembly 14 being located in a first position whereat it is capable of locking the lid 16a, 16b in the closed position. An opening 70 is provided in the perimeter wall 20 of the plate 12, thereby allowing a person access with a finger to push the button formed by the enlarged proximal end 62. Referring to FIG. 16, by pushing the enlarged proximal end 62 (indicated by arrow F), the locking assembly 14 is caused to move longitudinally further into the plate 12 to a second position thereby compressing the spring 58 between the locking assembly 14 and distal channel end wall 72. Inward travel is limited by engagement between the locking assembly 14 and a wall defining the channel 64 such as, for example, engagement between the intermediate body 60 and a distal wall 74 of the intermediate channel portion 64b and/or engagement between the enlarged proximal end 62 and first lateral structure 66. At the second position, the lids 16a, 16b may freely be moved from to the open position, unrestricted by the locking assembly 14.

Upon release of applied force (F) to the enlarged proximal end 62, the locking assembly 14 returns to the first position as illustrated in FIG. 14. In particular, the spring 58 resiliently urges the locking assembly 14 towards the opening 70 until the locking assembly 14 engages a wall defining the channel 64 such as, for example, by engagement between the intermediate body 60 and a proximal wall 76 of the intermediate channel portion 64b. Ideally, the enlarged proximal end 62 is flush or slightly recessed with the perimeter wall 20 in order to be less apparent to infants and small children. To avoid detection it is also preferred to orient the outlet cover 10 so that the enlarged proximal end 62 is at the bottom of cover 10 facing a floor.

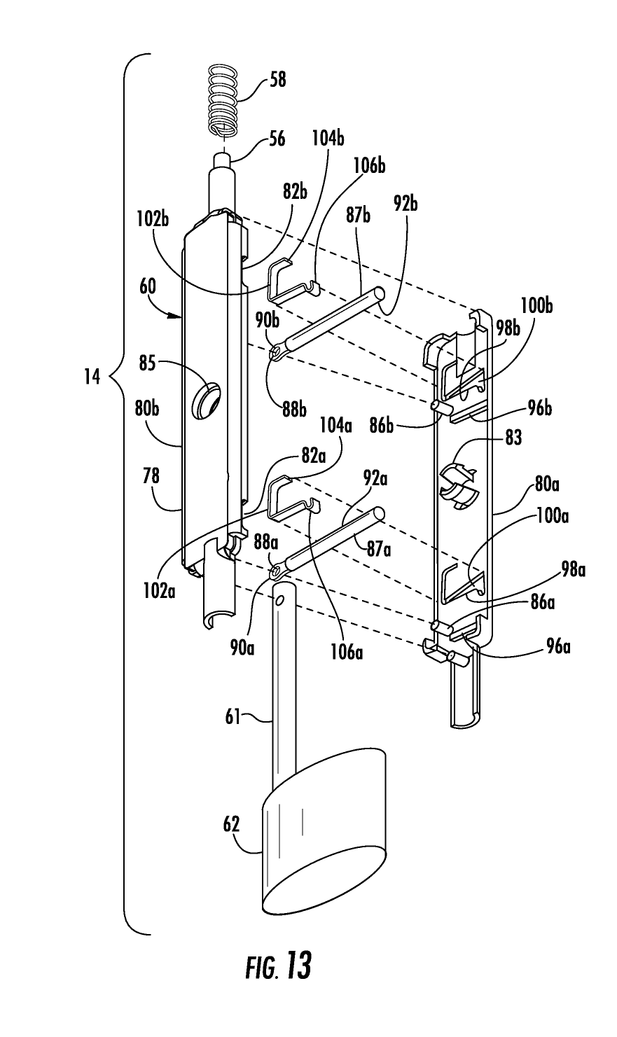

Referring to FIGS. 11-13, the intermediate body 60 includes a housing 78 having first and second sections 80a, 80b and first and second apertures 82a, 82b through which first and second locking pins 87a, 87b extend. The first section 80a includes a prong 83 (FIG. 13) whereas the second section 80b includes a corresponding opening 85 in order to snap the sections 80a, 80b together to form the housing 78. Other mating features, or means for attaching such as adhesives, fasteners or the like, may be provided to secure the first and second sections 80a, 80b together.

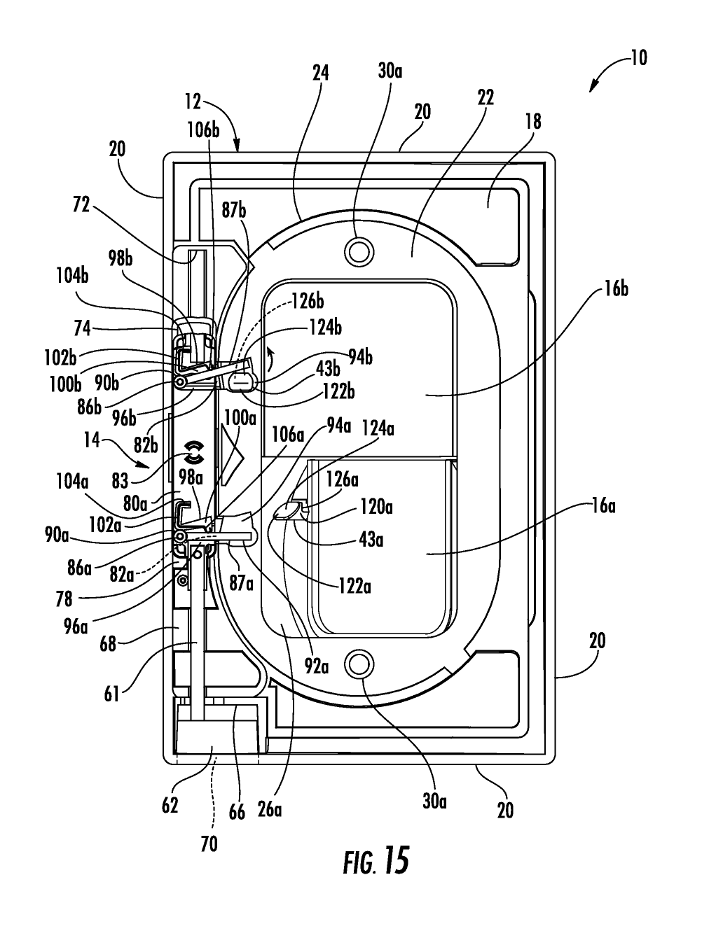

Referring to the FIGS. 13-16, the second section 80b (FIG. 13) is removed from the first section 80a in order to illustrate details within the body 60. The body 60 includes first and second pegs 86a, 86b which extend from the first section 80a; first and second elongate pins 87a, 87b, each having an opening 88a, 88b (FIG. 13) at a first end portion 90a, 90b for rotatably mounting the pins 87a, 87b on respective first and second pegs 86a, 86b and a second end portion 92a, 92b having a sufficient length so to extend through respective first and second apertures 82a, 82b and into respective openings 94a, 94b (FIGS. 14-15) provided within the second section 22 of the plate 12; first and second distal walls 96a, 96b which provide an abutment to restrict the degree of pin 86a, 86b rotation proximally; first and second wall structures 98a, 98b, which in combination with the first and second housing sections 80a, 80b (see FIGS. 11-13 for housing section 80b) define respective first and second compartments 100a, 100b; first and second springs 102a, 102b disposed within respective first and second compartments 100a, 100b; and each of the first and second springs 102a, 102b having a first and second end portions 104a, 104b, 106a, 106b, the first end portions 104a, 104b being tightly fitted within the respective compartment 100a, 100b such that the first portions 104a, 104b are fixed in location relative to the compartment 100a, 100b, the second end portions 106a, 106b being able to move annularly within the compartments 100a, 100b, preferably by a range of at least 5 degrees to up to 45 degrees, more preferably at least 5 degrees up to 35 degrees, and most preferably by a range of at least 5 degrees to no more than 25 degrees, before being stopped by engaging respective wall structures 98a, 98b. The second end portions 106a, 106b of the first and second springs 102a, 102b engage respective first and second locking pins 87a, 87b thereby continuously applying force to rotate the pins 87a, 87b proximally towards the locking position.

During use, the pins 87a, 87b may be located in the locking position, intermediate position and unlocking position. The following examples are illustrative of methods of use of the locking assembly 14 of the outlet cover 10.

Referring to FIG. 14, when the locking assembly 14 is in the first position and the lids 16a, 16b are either in the open position (lid 16a) or closed locked position (lid 16b), then the first and second locking pins 86a, 86b are in the locking position. When a pin (e.g. 87b) is in the locking position and a corresponding lid (e.g. 16b) is simultaneously in the closed position, the locking assembly 14 will cause the lid 16b to be locked in the closed position. Referring to FIG. 16, to release the lid 16b, force (F) is applied to enlarged end 62 causing the locking assembly 14 to move from a first position to a second position, carrying the pin 87b from the locking position to the unlocking position.

Referring to FIG. 15, when the locking assembly 14 is in the first position and a lid, e.g. lid 16b, is in the transitional position, then the locking pin, e.g. second pin 87b, is in the intermediate position between the locking position and unlocking position. (See FIG. 15 for an arrow indicating the motion of the second pin 87b from the locking position, through the intermediate position, to the unlocking position). The lid 16b is in the transitional position when the sloped surface 124b of the latch 43b is engaged with the second locking pin 87b as occurs just before the lid 16b reaches the closed position. As the lid 16b is closing, the latch 43b engages the second pin 87b causing the pin 87b to slide over the sloped surface 124b while pivoting in a generally distal direction (see arrow in FIG. 15) until the second portion 122b has moved past the second pin 87b. Thereafter, the second pin 87b will be caused, under the force of the second spring 102b, to move into the locking position where it resides in the catch 126b of the latch 43b. In this position, the lid 16b is unable to be opened due to engagement of the second portion 122b against the second locking pin 87b until the locking assembly 14 is moved to the second position.

Referring to FIG. 16, upon applying sufficient force (F) on the enlarged proximal end 62, the locking assembly 14 is caused to move longitudinally distally from the first position to the second position, carrying the first and second pins 86a, 86b from the locking position to the unlocking position whereby the lids 16a, 16b can be freely rotated to the open position.

Referring to FIGS. 17-19, a template 29a is illustrated for use with the invented outlet cover 10. The template 29a adapts the cover 10 for use with a standard duplex outlet. The template 29a includes a member 150 defining a pair of openings 26b for accessing an outlet, arrow shaped guides 152 having a shaft 154 and arrow head end portion 156, and openings 162 for accommodating protrusion of the latches (only latch 43b shown). Extra openings 162 are provided so that the template 29a is reversible. The template 29a sits on the second section 22 and within the first guide wall 158 to properly position the template 29a. The arrow shaped guides 152 also assist in positioning the template 29a by having the shafts 154 extend through cut-outs 160 in the first guide wall 158 and the arrow head end portions 156 confined by second guide wall of the outlet cover 10.

Referring to FIGS. 20-22, a template 29b is illustrated for use with the invented outlet cover 10. The template 29b adapts the cover 10 for use with a GFI duplex outlet. The template 29b includes a member 170 defining an opening 26a for accessing an outlet, arrow shaped guides 172 having a shaft 174 and arrow head end portion 176, and openings 184 for accommodating protrusion of the latches (only latch 43b shown). Extra openings 184 are provided so that the template 29b is reversible. The template 29b sits on the second section 22 and within the first guide wall 178 to properly position the template 29b. The arrow shaped guides 172 also assist in positioning the template 29b by having the shafts 174 extend through cut-outs 180 in the first guide wall 178 and the arrow head end portions 176 confined by second guide wall 182 of the outlet cover 10.

It is contemplated and within the scope of this application that the invented outlet cover may be modified to have more or less of the elements, and that the elements may be of different shapes and sizes, than that described herein and still perform an equivalent function. For example, the invented outlet cover may be configured with a singular lid, include three of more lids, and/or having openings suitable for application with different types of electrical receptacles, and the like. It is further contemplated that different means for allowing the locking pins to move between the locking, intermediate and unlocking positions may be provided. For example, an arrangement of pins and compression springs may allow for the pins to move linearly, instead of radially has described herein with the preferred embodiments.

The foregoing provides a detailed description of exemplary embodiments of the present invention. Although an outlet cover with a locking assembly for use with an electrical outlet has been described with reference to preferred embodiments and examples thereof, other embodiments and examples may perform similar functions and/or achieve similar results. All such equivalent embodiments and examples are within the spirit and scope of the present invention and are intended to be covered by the following claims.

That which is claimed is:

1. An outlet cover for an electrical outlet, comprising:
a plate having at least one opening capable of receiving an electrical plug;
a lid hingedly attached to the plate so that the lid can be moved between an open position that allows access to the electrical outlet and a closed locked position wherein the electrical outlet is covered by the lid and the lid cannot be freely moved to the open position, the lid having a latch;
a locking assembly having a pin movable between an locked position, a transitional position, and an opening position; and
wherein the pin secures the latch whereby the lid is locked in a closed position.

2. An outlet cover for an electrical outlet, comprising:
a plate having an opening capable of receiving an electrical plug;
a lid hingedly attached to the plate so that the lid can be moved between an open position that allows access to the opening and a closed locked position wherein the opening is covered by the lid and the lid cannot be freely moved to the open position; and
a locking assembly have a pin, the locking assembly being moveable between a first position wherein the lid is capable of being locked in the closed position by the pin and an open position wherein the lid may be freely moved to the open position.
